(19) United States
(12) Patent Application Publication
(10) Pub. No.: US 2010/0285754 A1
(43) Pub. Date: Nov. 11, 2010

(54) RADIO EQUIPMENT, AND METHOD AND PROGRAM OF DETERMINING SIGNAL TRANSMISSION SPEED

(76) Inventor: Yoshitaka Kawanabe, Saitama (JP)

Correspondence Address: Mr. Jackson Chen, 6535 N. STATE HWY 161, IRVING, TX, 75039, US

(21) Appl. No.: 12/811,908

(22) PCT Filed: Mar. 16, 2009
(86) PCT No.: PCT/JP2009/055072

§ 371 Date: Jul. 7, 2010

(30) Foreign Application Priority Data
Mar. 17, 2008 (JP) 2008-068405
Mar. 13, 2009 (JP) 2009-061124

(51) Int. Cl. H04B 17/00

(52) U.S. Cl. 455/67.16

(57) ABSTRACT

It is possible to determine a signal transmission speed in a signal transmission system operated by radio equipment upon receiving transmission of a base band signal from a radio equipment control (REC) and operates on the signal. The radio equipment that operates by receiving transmission of a base band signal from a radio equipment control includes: an interface section that generates a parallel signal and a clock signal based on the base band signal; a control section that outputs a signal of a specified value to be compared with the clock signal generated by the interface section; and a clock circuit that detects whether or not the clock signal generated by the interface section coincides with the signal of the specified value outputted from the control section, and outputs a coincidence signal when both of the signals coincide with each other.

### TECHNICAL FIELD

The present invention relates to a mobile-communication radio base station device structured by connecting a radio equipment control and radio equipment via a communication line such as an optical fiber. More specifically, the present invention relates to determining the transmission speed on the radio equipment side.

### BACKGROUND ART

As a mobile-communication radio base station device, there is such a type structured by connecting a radio equipment control as a master device and radio equipment as a slave device via a communication line such as an optical fiber. For the devices of such form, there is a standard specification called CPRI (Common Public Radio Interface) as an optical or electric signal interface connecting a radio equipment control (REC) and the radio equipment (RE).

In CPRI (Specification v3.0), four kinds of transmission speeds such as 614.4 Mbps, 1228.8 Mbps, 2457.6 Mbps, and 3072.0 Mbps are provided. It is for allowing an operator who operates a mobile-communication radio base station device to determine and use the CPRI standard corresponding to which of the transmissions speeds and for allowing a vendor who manufactures the mobile-communication radio base station devices to provide the one that matches the request to the operator. Therefore, it is necessary on the radio equipment side to determine the transmission speed of a base band signal transmitted from the master device among the speeds provided on the standard.

Regarding automatic determination of an optical transmission system, particularly the transmission speed, there are following documents of related techniques. Patent Document 1 depicts a technique which superimposes transmission speed information on an output signal of a light transmitter, and a control monitor signal thereof is extracted by a lowpass filter to determine the transmission speed on a light receiver side. Patent Document 2 depicts a technique which detects an inherent data bit pattern from a framing byte within a transmission signal to determine the transmission speed.

Patent Document 3 depicts a CDR (Clock and Data Recovery) circuit for a programmable logic device which detects each of lock and unlock states, and changes a set value of the transmission speed in case of an unlock state. Patent Document 4 depicts a data-transmission serial interface which downloads software corresponding to the transmission speed in a lock state.

Patent Document 5 depicts a technique which provides a plurality of voltage control oscillators, and changes the frequency by switching the voltage control oscillators one after another with a switching device. Patent Document 6 depicts a technique which switches voltage control oscillators with a switching device, when detecting an unlock state.

### Patent Document 1: Japanese Unexamined Patent Publication 2003-244075

### Patent Document 2: Japanese Unexamined Patent Publication 2002-204226

### Patent Document 3: Japanese Unexamined Patent Publication 2003-527034

### Patent Document 4: Japanese Unexamined Patent Publication 2006-302277

### Patent Document 5: Japanese Unexamined Patent Publication Sho 62-203423

### Patent Document 6: Japanese Unexamined Patent Publication Hei 04-330675

### DISCLOSURE OF THE INVENTION

### Problems to be Solved by the Invention

With the technique of Patent Document 1, it is necessary to superimpose the transmission speed on the signal as the information. Thus, the format of optical signals thereof becomes a unique format, so that the technique cannot be utilized under the already-standardized specifications. Further, the transmission speed information is extracted by a lowpass so that used therewith are only the frequency components that lowpass-filters the LPF (lowpass filter). This becomes a restriction when determining the frequency component of the control monitor signal. With the technique of Patent Document 2, the format of transmitted signals needs to be already known in order to detect the inherent data bit pattern from the framing byte.

Further, while Patent Document 3 discloses the technique of “detecting lock/unlock” and “changing the set value of the transmission speed in a case of unlock state”, this merely shows an example of a CDR circuit. Similarly, Patent Document 4 merely shows an example of a method for downloading software corresponding to the transmission speed. Patent Documents 3, 4 and Patent Documents 5, 6 are different in terms of the usages and objects from those of the radio equipment That is, it is not possible to automatically determine the transmission speed with the radio equipment and process the signals with a format corresponding to that without changing the world standard specifications even when the techniques of Patent Documents 1, 2 and further the techniques of Patent Documents 3-6 are combined.

An object of the present invention is to provide radio equipment and a method as well as a program of determining signal transmission speed, which can process signals with a format corresponding to the transmission speed by automatically determining the transmission speed without changing the world standard specifications.

### Means for Solving the Problems

In order to achieve the foregoing object, the radio equipment according to the present invention is a radio equipment that operates by receiving transmission of a base band signal from a radio equipment control (REC), and the radio equipment includes: an interface section that generates a parallel signal and a clock signal based on the base band signal; a control section that outputs a signal of a specified value to be compared with the clock signal generated by the interface section; and a clock circuit that detects whether or not the clock signal generated by the interface section coincides with the signal of the specified value outputted from the control section, and outputs a coincidence signal when both of the signals coincide with each other.

In the explanations above, the present invention is built as the radio equipment. However, the present invention is not limited to the case of being built as hardware. The present invention may also be built as a signal transmission speed determining method and a determining program as software.

When the present invention is built as a method, the signal transmission speed determining method according to the present invention is a method that determines a signal transmission speed in a signal transmission system operated by radio equipment upon receiving transmission of a base band signal from a radio equipment control (REC), and the method includes: generating a parallel signal and a clock signal based on the base band signal; outputting a signal of a specified value to be compared with the clock signal; and detecting whether or not the clock signal coincides with the signal of the specified value, and outputting a coincidence signal when both of the signals coincide with each other.

When the present invention is built as a program of software, the signal transmission speed determining program according to the present invention is a program that determines a signal transmission speed in a signal transmission system operated by radio equipment upon receiving transmission of a base band signal from a radio equipment control (REC), and the program causes a computer to execute: a function that generates a parallel signal and a clock signal based on the base band signal; a function that outputs a signal of a specified value to be compared with the clock signal; and a function that detects whether or not the clock signal coincides with the signal of the specified value, and outputs a coincidence signal when both of the signals coincide with each other.

### EFFECTS OF THE INVENTION

With the present invention, it is possible to compare the clock signal generated based on the signals transmitted to the signal transmission system with the signal of the specific value, and to automatically determine the transmission speed of the signals transmitted to the signal transmission system based on the comparison result without changing the world standard specifications.

### BEST MODES FOR CARRYING OUT THE INVENTION

Hereinafter, embodiments of the present invention will be described in details by referring to the drawings.

### First Exemplary Embodiment

FIG. 1 is a block diagram showing the structure of a mobile-communication radio base station device 1 according to a first exemplary embodiment of the invention. A radio equipment control (REC) 10 shown in FIG. 1 is a master device of the mobile-communication radio base station device 1, and radio equipment 20 shown in FIG. 1 is a slave device. In FIG. 1, the radio equipment 20 is a separated transmitter-and-receiver part of the mobile-communication radio base station device 1. An optical fiber 11 transmits a digital base band signal between the REC 10 and the radio equipment 20.

The radio equipment 20 includes a transmission-and-reception control section 21, a receiver 22, a transmitter 23, a filter 24, and an antenna 25. The transmission-and-reception control section 21 has an interface function with respect to the REC 10, and interfaces with the receiver 22 and the transmitter 23 by executing base band processing.

The receiver 22 includes a low-noise amplifier, a frequency converter, an interference wave suppressing filter, and the like, converts a reception signal from the filter 24 into a digital signal, and outputs the signal to the transmission-and-reception control section 21. The transmitter 23 executes analog conversion, frequency conversion, unnecessary wave suppression on the digital signal from the transmission-and-reception control section 21, amplifies those to the specified output power, and outputs it to the filter 24.

The filter 24 is connected to the antenna 25, and performs suppression of the interference signal for the reception signal from the antenna 25 and suppression of the unnecessary wave in the output signal from the transmitter 23. The antenna 25 receives the reception signal and transmits the transmission signal.

FIG. 2 is a block diagram showing the more detailed structure of the transmission-and-reception control section 21 shown in FIG. 1. The transmission-and-reception control section 21 includes an electro-optic conversion section 31, an interface section 32, a format conversion section 33, a base band processing section 34, a clock circuit 35, a control section 36, a switch 37, and memories 38a, 38b.

The electro-optic conversion section 31 converts a signal A as an optical signal into a signal B as a serial electric signal B. The interface section 32 converts the signal B inputted from the electro-optic signal converting section 31 into a signal K as a parallel electric signal and generates a signal C as a clock signal from the signal B. The format conversion section 33 performs synchronization of the signals and extracts a data part to be outputted to the base band processing section 34 by corresponding to the format of the signal K outputted from the interface section 32 by having a signal D generated by the clock circuit 35 to be described later as a trigger, and outputs it as a signal L.

The base band processing section 34 executes base band processing of the signal L generated by the format conversion section 33. The clock circuit 35 is formed with an oscillator and a PLL, and the PLL and the oscillator of the clock circuit 35 operate with a signal E from the control section 36. The clock circuit 35 compares the signal C from the interface section 32 with the signal E from the control section 36 by having the signal C as a reference signal. The clock circuit 35 outputs the signal D as a coincidence signal when those signals coincide with each other, and outputs a non-coincidence signal when those signals do not coincide with each other. Further the clock circuit 35 outputs a signal F which indicates a case where the signal C and the signal E coincide with each other and a case where the signal C and the signal E do not coincide with each other to the control section 36. The control section 36 receives the signal F from the clock circuit 35, and outputs a signal E with a different specified value to the clock circuit 35 by having a case where the signals C and D do not coincide with each other as a trigger. More specifically, the clock circuit 35 outputs the signal D when the signal C and the signal E coincide with each other, i.e., when the PLL is locked, and outputs a non-coincidence signal when the signal C and the signal E do not coincide with each other, i.e., when the PLL is unlocked. Further, the clock circuit 35 outputs the signal F which shows the state where the PLL is locked and the state where the PLL is unlocked to the control section 36.

The control section 36 outputs the signal E for setting the operating frequency of the clock circuit 35 to the clock circuit 35 based on the signal F from the clock circuit 35, and outputs a signal G for controlling the switch 37. The switch 37 switches the paths (signal H and signal I) of the memories 38a and 38b based on the signal G from the control section 36, and outputs the signal H or I outputted from the memory 38a or 38b to the format conversion section 33 as a signal J. Specifically, the memories 38a and 38b store software corresponding to two kinds of transmission speeds, respectively, for operating the format conversion section 33, and output the software indicated by the control section 36 via the switch 37 as the signal H or I. The switch 37 sends out the signal (software) H or I outputted from the memory 38a or 38b to the format conversion section 33 as a signal J.

FIG. 3 is a block diagram showing the more detailed structure of the interface section 32 shown in FIG. 2. The interface section 32 includes a serial conversion section 41, a parallel conversion section 43, a CDR section 45, and buffer sections 42, 44.

The buffer section 42 receives the signal from the format conversion section 33. The serial conversion section 41 converts the signal received from the buffer section 42 into a serial signal, and outputs it to the electro-optic conversion section 31. The parallel conversion section 43 converts the signal B from the electro-optic conversion section 31 into a parallel signal, and outputs it to the CDR section 45 and the buffer section 44.

The buffer section 44 receives the signal of the parallel conversion section 42, and sends it to the format conversion section 33 as the signal K. The CDR conversion section 45 has a CDR (Clock and Data Recovery) function which extracts a clock from the parallel signal received from the parallel conversion section 43 and generates a reproduction clock, and outputs the generated reproduction clock to the clock circuit 35 as the signal C.

FIG. 4 is a block diagram showing the more detailed structure of the clock circuit 35 shown in FIG. 2. The clock circuit 35 includes a PLL (Phase Locked Loop) 51, an oscillator 52, and a switch 53. The PLL 51 sets the oscillation frequency of the oscillator 52 to the frequency indicated by the signal E of the control section 36 by having the signal C from the interface section 32 as a reference. The oscillator 52 returns the output signal to the PLL 51, and outputs the output signal to the switch 53. The PLL 51 executes an operation by receiving the signal from the oscillator 52. The switch 53 sets on the output of the signal D when the signal F shows that the PLL is locked, and sets off the output of the signal D when the signal F from the PLL 51 shows the unlock state.

While the signal A is assumed to be the optical signal in the exemplary embodiment described above, the signal A may be an electric signal. In that case, the optical fiber 11 is replaced with an electric-signal cable such as a coaxial cable, and the electro-optic conversion section 31 is omitted.

FIG. 5 is a flowchart showing the operation at the time of starting up the radio equipment 20 shown in FIG. 2-FIG. 4. When the power of the radio equipment 20 is turned on and the optical signal A is inputted to the electro-optic conversion section 31, the electro-optic conversion section 31 converts it to the electric signal B and outputs it (step S101).

When the signal B is inputted, the parallel conversion section 43 within the interface section 32 generates an electric signal containing data and a clock signal from the electric signal based on the signal B. The CDR section 43 generates a reproduction clock corresponding to the transmission speed of the signal A based on the clock signal, and outputs the reproduction clock to the clock circuit 35 as the signal C (step S102).

When the control section 36 starts to operate by turning on the power, the control section 36 outputs the signal E which shows a set value S1 for the PLL 51 that is provided inside the clock circuit 35 (step S103). The PLL 51 of the clock circuit 35 sets the operating frequency according to the set value S1 based on the signal E, and outputs the signal of the set frequency to the oscillator 52. The oscillator 52 receives the signal from the PLL 51, and sets the oscillation frequency to the frequency that is determined according to the set value S1 (step S104). Note here that the set value S1 is a set value that is determined in advance by taking the frequency of the signal A as a premise.

The PLL 51 set to the determined frequency judges whether or not the oscillation frequency of the oscillator 52 is locked (step S105), and outputs the result to the control section 36 as the signal F.

Note here that “the frequency is locked” means that the PLL 51 compares the frequency of the signal C from the interface section 32 with the oscillation frequency of the oscillator 52 and judges that the PLL 51 is locked when those coincide with each other. Hereinafter, the state where the frequency is locked is refereed to as a lock state, and the state other than that is refereed to as an unlock state. The processing is advanced to step S106 in a lock state, and the processing is advanced to step S109 in an unlock state.

In a case where it is judged as being in the lock state in step S105 and the processing is advanced to step S106, the control section 36 upon receiving the signal F indicating that it is in the lock state controls the switch 37 to switch the path to select the memory 38a so as to use the memory 38a where the software of the format conversion section 33 corresponding to the set value S1 is stored (step S106). The memory 38a reads out the stored software, and outputs the software to the switch 37. The format conversion section 33 downloads the software read out by the memory 38a via the switch 37, and the format conversion section 33 starts up by the received software (step S107).

When the start-up is completed, the format conversion section 33 can recognize the format of the signal received from the interface section 32, and can transfer the signal to the base band processing section 34 (step S108). Thereby, the radio equipment 20 can operate properly.

In a case where it is judged as being in an unlock state in step S105 and the processing is advanced to step S109, the control section 36 upon receiving the signal F indicating that it is in the unlock state judges that the frequency of the signal C outputted from the interface section 32 is different from the set value S1, and outputs the signal E with a set value S2 obtained by assuming a different frequency to the clock circuit 35 (step S109). The PLL 51 of the clock circuit 35 receives the signal E from the control section 36, and sets the operating frequency based on the set value S2. The oscillator 52 receives the signal E from the PLL 51, and sets the oscillation frequency to the oscillation frequency based on the specified value S2 (step S110).

When the oscillator 52 sets the oscillation frequency to the frequency based on the specified value S2, the PLL 51 outputs the signal indicating that it is in a lock state showing that the frequency is locked to the control section 36 as the signal F upon receiving the signal of the oscillation frequency based on the specified value S2 from the oscillator 52 (step S111). The control section 36 upon receiving the signal F switches the path to select the memory 38b by controlling the switch 37 so as to use the memory 38b where the software of the format conversion section 33 corresponding to the set value S2 is stored (step S112).

The memory 38b outputs the stored software to the switch 37. The format conversion section 33 downloads the software read out by the memory 38b via the switch 37 by having the signal D from the clock circuit 35 as a trigger, and starts up based on the software (step S113). When the start-up is completed, the format conversion section 33 can recognize the format of the signal received from the interface section 32, and can transfer the signal to the base band processing section 34 (step S114).

As a specific example of the above-described operation, a case where two kinds of transmission speeds such as 1228.8 Mbps and 2457.6 Mbps among the transmission speeds standardized in CPRI are applied will be described. In FIG. 5, the set value S1 and the software within the memory 38a correspond to the transmission speed of 1228.8 Mbps, while the set value S2 and the software within the memory 38b correspond to the transmission speed of 2457.6 Mbps.

The transmission speed of 1228.8 Mbps is used as CPRI, and the frequency of the reproduction clock (signal C) outputted from the interface section 32 is 122.88 MHz. The set value S1 outputted from the control section 36 is the set value for outputting the signal D of 122.88 MHz by having the signal C as the reference, so that the clock circuit 35 comes to be in a lock state.

Therefore, the control section 36 switches the path of the switch 37 so as to use the software of the memory 38a, and the format conversion section 33 downloads the software of the memory 38a. The software within the memory 38a is the software corresponding to the transmission speed of 1228.8 Mbps. Thus, signal processing of the signal inputted to the format conversion section 33 is executed, and it is outputted to the base band processing section 34.

Further, in a case where the transmission speed of 2457.6 Mbps is used, the frequency of the signal C outputted from the interface section 32 becomes 245.76 MHz. The set value S1 outputted first from the control section 36 is the value set by having the signal C of 122.88 MHz as the reference, so that the frequency of the signal C is different. Thus, the clock circuit 35 cannot be locked to the designated frequency, thereby outputting the signal F as being in an unlock state.

Here, the control section 36 outputs the set value S2 corresponding to the transmission speed of 2457.6 Mbps as the signal E. In this case, it is the value set by having the signal C of 245.76 MHz as the reference, so that the clock 35 comes to be in a lock state and outputs the signal F. Thus, the control section 36 switches the path of the switch 37 for using the software of the memory 38b, and the format conversion section 33 downloads the software of the memory 38b.

The software within the memory 38b is the software corresponding to the transmission speed of 2457.6 Mbps, so that the format conversion section 33 executes signal processing of the inputted signal, and outputs the result of the signal processing to the base band processing section 34.

FIG. 6 is a flowchart showing the operation of a case where it is switched to CPRI of 1228.8 Mbps, when the radio equipment 20 shown in FIG. 2-FIG. 4 is operating by corresponding to the transmission speed of 2457.6 Mbps. By conforming to the explanation of FIG. 5 provided above, it is assumed that the memory 38b stores the software corresponding to the transmission speed of 2457.6 Mbps and the memory 38a stores the software corresponding to the transmission speed of 1228.8 Mbps. It is assumed that the control section 36 outputs the signal E of the specified value S1 by corresponding to the transmission speed of 2457.6 Mbps and outputs the signal E of the specified value S2 by corresponding to the transmission speed of 1228.6 Mbps.

When the specification is changed to CPRI specification of 1228.8 Mbps by exchanging the REC, for example, in the REC 10 and the radio equipment 20 operated by corresponding to the transmission speed of 2457.6 Mbps (step S210), the frequency of the signal C that is the reproduction clock generated by the interface section 32 changes from 245.76 MHz to 122.88 MHz (step S202).

The clock circuit 35 comes to be in an unlock state in accordance with the change in the frequency of the signal C, and outputs the signal F (step S203). The control section 36 upon receiving the signal F outputs the set value S1 as the signal E (step S204). The clock circuit 35 comes to be in a lock state by the set value S1 which corresponds to the signal C of 122.88 MHz, and outputs the signal F to the control section 36 (step S205). The control section 36 upon receiving the signal F controls the switch 37 to switch the path to the memory 38a (step S206).

The format conversion section 33 upon downloading the software within the memory 38a re-starts up the software corresponding to the 1228.8 Mbps (step S207). Thereby, the format conversion section 33 re-starts the signal processing (step S208), and the radio equipment 20 can be switched to the device corresponding to the CPRI of 1228.8 Mbps.

In the first exemplary embodiment of the invention described above, the control section 36 judges the lock state or the unlock state of the clock circuit according to the frequency of the clock signal C outputted from the interface section 32. Thereby, the radio equipment 20 can set the clock circuit in accordance with the frequency of the clock signal outputted from the interface section 32. Further, it is possible for the control section 36 to judge the format of the optical signal, and to start up the radio equipment 20 by using the software corresponding to that format.

In the example described above, the two memories 38a and 38b are used to correspond to the two kinds of transmission speeds. However, this can be easily expanded to correspond to the transmission speeds of three or more kinds. Further, it is also possible to use different communication formats and protocols for each of the transmission speeds.

### Second Exemplary Embodiment

FIG. 7 is a block diagram showing the structure of radio equipment 320 of a mobile-communication radio base station device according to a second exemplary embodiment of the invention. The overall structure of the mobile-communication radio base station device is the same as the overall structure of the mobile-communication radio base station device 1 according to the first exemplary embodiment of the invention shown in FIG. 1, except that the radio equipment 20 is replaced with the radio equipment 320. Further, the radio equipment 320 also includes many of the structural elements that are the same as those of the radio equipment 20 according to the first exemplary embodiment of the invention shown in FIG. 2, so that same reference numerals are applied to the same elements and explanations thereof are omitted.

A transmission-and-reception control section 321 in the radio equipment 320 is obtained by adding a synchronization detecting section 339 further to the transmission-and-reception control section 21 of the first exemplary embodiment. Other structures are the same as those of the first exemplary embodiment. The clock circuit 35 outputs a signal D to the format conversion section 33 and the synchronization detecting section 339 simultaneously, when it comes to be in a lock state. The memory 38a stores software used for initial startup of the format conversion section 33. The memory 38b does not store any software in, an initial state but stores software sent from the synchronization detecting section 339 when the synchronization detecting section 339 operates.

Upon detecting the signal D from the clock circuit 35, the synchronization detecting section 339 synchronizes the signal D and the signal K from the interface section 32. When synchronization is established by the synchronization detecting section 339, the radio equipment 320 and the REC 10 can be synchronized. Thus, the REC 10 outputs the software for the format conversion section 33, and the synchronization detecting section 339 receives the software from the REC 10 by the signal K. The synchronization detecting section 339 sends the received software to the memory 38b as a signal M, and the memory 38b stores the software from the synchronization detecting section 339.

FIG. 8 is a flowchart showing the operation when the radio equipment 320 shown in FIG. 7 starts up. When the power of the radio equipment 320 is turned on and an optical signal A of an unknown transmission speed is inputted to the electro-optic conversion section 31, the electro-optic conversion section 31 converts it to an electric signal B and outputs it (step S401).

When the signal B is inputted to the interface section 32, the parallel conversion section 42 within the interface section 32 generates an electric signal containing data and a clock signal from the electric signal based on the signal B. When the clock signal is inputted to the CDR section 43, the CDR section 43 generates a reproduction clock corresponding to the transmission speed of the signal A based on the clock signal, and outputs the reproduction clock as the signal C of an unknown frequency to the clock circuit 35 (step S402). At this stage, the frequency of the signal C to be outputted from the CDR section 43 to the clock circuit 35 is unknown. Here, “n” that is “0” or a positive integer is set initially as “n=0”.

When the control section 36 starts to operate by turning on the power, the control section 36 outputs the signal E showing a set value S(n) as an initial value to the clock circuit 35 (step S403). Therefore, the clock circuit 35, particularly the PLL 51 and the oscillator 52 start the operation according to the signal C of the unknown frequency and the specified value S(n) from the control section 36 (step S404).

Upon starting the operation, the clock circuit 35 checks the state of the PLL 51 and outputs the signal F showing the lock state or the signal F showing the unlock state to the control section 36 (step S405). Upon receiving the signal F showing the unlock state from the clock circuit 35, the control section 36 changes the specified value S(n) to a new specified value S(n+1), and outputs the signal E showing the specified value S(n) to the clock circuit 35 (step S406). Note here that the specified value S(n+1) shows the new specified value changed from the reference specified value S(n) by the control section 36, and the specified value S(n+1) means to shift the counter setting within the PLL 51 of the clock circuit 35 corresponding to the specified value S(n) by “1”. When the clock circuit 35 receives the new specified value S(n+1) from the control section 36, the PLL 51 of the clock circuit 35 operates based on the signal C of the unknown frequency and the specified value S(n+1) from the control section 36. Then, the clock circuit 35 checks the state of the PLL 51. The control section 36 continues to output the new specified value S(n+1) until the state of the PLL 51 within the clock circuit 32 changes to the lock state from the unlock state, and the PLL 51 of the clock circuit 35 continues the operation until the state shifts to the lock state based on the signal C of the unknown frequency and the specified value S(n+1) from the control section 36 (step S403-step S406).

When the state of the PLL 51 shifts to the lock state, the clock circuit 35 outputs the signal F showing that state to the control section 36 (YES in step S405).

At the point where the clock circuit 35 outputs the signal F showing the lock state of the PLL 51 to the control section 36, the control section 36 switches the path to select the memory 38a by controlling the switch 37 (step S407).

The format conversion section 33 receives the signal D from the clock circuit 35, downloads the software within the memory 38a as the software for initial startup, and starts up by the software (step. S408). Further, the clock circuit 35 outputs the signal D to the synchronization detecting section 339 at the point where the PLL 51 shifts to the lock state (step S409).

The synchronization detecting section 339 synchronizes the signal D received from the clock circuit 35 and the signal K received from the interface section 32 (step S410). When the synchronization detecting section 339 detects that synchronization between the signal D and the signal K is established, synchronization between the REC 10 and the radio equipment 20 is established. When the synchronization is established, the REC 10 outputs the software for the format conversion section 33 towards the radio equipment 20. The synchronization detecting section 339 receives the software from the REC 10 based on the signal K (step S411), and outputs the software to the memory 38b as the signal M. The memory 38b stores the software from the synchronization detecting section 339 (step S412).

When the software from the REC 10 is stored to the memory 38b properly, the control section 36 switches the path to the memory 38b by controlling the switch 37 (step S413). The format conversion section 33 downloads the software corresponding to the unknown signal A stored in the memory 38b, and starts up by the software from the REC 10 acquired from the memory 38b instead of the software for the initial startup acquired from the memory 38a (step S414). Thereby, the format conversion section 33 can start signal processing, and can send the signal to the processing after the base band processing section 34 (step S415).

In the second exemplary embodiment of the invention described above, it is possible to search the frequency of the unknown signal through changing the set value of the clock circuit 35 and to download and use the software for the format conversion section 33 corresponding to the unknown signal at the point where the clock circuit 35 comes to be in a lock state and the format conversion section 33 comes to synchronize with the optical signal. This makes it possible to perform operations by corresponding to new transmission speed and format of the optical signal, which are newly specified.

### Third Exemplary Embodiment

FIG. 9 is a block diagram showing the structure of radio equipment 520 of a mobile-communication radio base station device according to a third exemplary embodiment of the invention. The overall structure of the mobile-communication radio base station device is the same as the overall structure of the mobile-communication radio base station device 1 according to the first exemplary embodiment of the invention shown in FIG. 1, except that the radio equipment 20 is replaced with the radio equipment 520, and the radio equipment 520 and the REC 10 are connected via two optical fibers 511a, 511b.

That is, the third exemplary embodiment shown in FIG. 9 is so characterized that: at least two signal transmission systems 511a and 511b for transmitting a signal between the REC 10 and the radio equipment 520 are provided; electro-optic conversion sections 531a, 531b, interface sections 531a, 531b, and format conversion sections 533a, 533b are disposed to each of the signal transmission systems 511a, 511b; a base band processing section 534, a clock circuit 535, and a control section 536 are used in common for the signal transmission systems 511a, 511b; and a switch 537 is disposed between at least the two signal transmission systems 511a, 511b and the common clock circuit 535.

In the explanations below, described by referring to FIG. 9 is a case where the optical fibers 511a, 511b for transmitting the optical signals are used as the signal transmission systems 511a, 511b, the signal transmission systems are two systems, and the transmission speeds of the optical signals transmitted to the optical fibers 511, 511b are set to be different in advance. For the signal transmission systems, cables which transmit electric signals may be used instead of the optical fibers which transmit the optical signals. Further, the signal transmission systems 511a and 511b are not limited only to be two systems.

More specific explanations will be provided. In a transmission-and-reception control section 521 of the radio equipment 520 shown in FIG. 9: the electro-optic conversion sections 531a, 531b, the interface sections 531a, 531b, and the format conversion sections 533a, 533b are disposed to each of the optical fibers 511a, 511b; the base band processing section 534, the clock circuit 535, and the control section 536 are used in common for the signal transmission systems 511a, 511b; and the switch 537 is disposed between at least the two signal transmission systems 511a, 511b and the common clock circuit 535.

The electro-optic conversion sections 531a and 531b respectively convert the signals A 1 and A2 which are the optical signals transmitted from the optical fibers 511a and 511b into signals B1 and B2 which are electric signals.

The interface sections 532a and 532b respectively input the serial electric signals B1, B2 converted by the electro-optic conversion sections 531a, 531b, convert those to parallel electric signals K1, K2, and further generates signals C1, C2 which are reproduction clocks.

The format conversion sections 533a and 533b take the signal D generated by the clock circuit 535 as the clock, performs synchronization of the signals and extraction of a data part to be outputted to the base band processing section 534 to be described later by corresponding to the format of the parallel signals K1, K2 outputted from the interface sections 532a, 532b, and output those as each of signals L1 and L2.

The base band processing section 534 executes the base band processing of the signals L1, L2 generated by the format conversion sections 533a, 533b, and synthesizes and distributes the signals L1, L2 according to the system. The switch 537 selects the paths of signals C1, C2 according to an instruction (signal N) of the control section 536. The control section 536 judges which of the signals C1 and C2 to be used, and controls the switch 537.

An example of the specifications of CPRI will be described herein. It is assumed that the optical signal of the transmission speed of 1228.8 Mbps is inputted as the signal A1, and the optical signal of the transmission speed of 2457.6 Mbps is inputted as the signal A2, respectively. In this case, the signal C1 outputted from the interface section 532a is the signal having the frequency of 122.88 MHz, and the signal C2 outputted from the interface section 532b is the signal having the frequency of 245.76 MHz. Those two signals are inputted to the switch 537.

The switch 537 receives the two signals C1 and C2 from the interface sections 532a, 532b as the input. In the initial state at the time of turning on the power, the switch 537 selects the signal C1 that is set as the initial value. Therefore, the switch 37 outputs the signal C1 from the interface section 532a as the initial value at the time of turning on the power to the clock circuit 535. At the point of receiving the signal C1 from the interface section 532a, the control section 536 outputs the signal E showing 1228.8 Mbps for making the interface section 532a as the reference to the clock circuit 35 as a specified value. The PLL 51 of the clock circuit 535 operates based on the signal C1 from the interface section 532a and the signal E from the control section 536. When the PLL is in a lock state, the clock circuit 535 outputs the signal D showing 1228.8 Mbps to each of the two format conversion sections 533a and 533b.

One format conversion section 533a functions by corresponding to the signal D showing 1228.8 Mbps from the clock circuit 535. The other format conversion section 533b starts up by having the signal D showing 1228.8 Mbps from the clock circuit as a startup signal, and function by corresponding to the signal A2 of 2457.6 Mbps.

In a case where it is desired to operate the radio equipment by having the interface section 533b operated in 2457.6 Mbps as the reference, the control section 536 is operated by a remote control from the REC 10, manual operations, or the like. Upon receiving the operation instruction, the control section 536 outputs a signal N showing the operation instruction to the switch 537, and outputs the signal E to the clock circuit 535 for changing the PLL 51 of the clock circuit 535 to be in a lock state. This signal E is the signal showing 2457.8 Mbps. Upon receiving the signal N from the control section 536, the switch 537 switches the contact to the interface section 532b to output the signal C2 from the interface section 532b to the clock circuit 535. The clock circuit 535 operates based on the signal C2 from the interface section 532b and the signal E showing 2457.8 Mbps from the control section 536. When the PLL 51 of the clock circuit 535 is in a lock state, the clock circuit 535 outputs the signal D showing 2457.8 Mbps to each of the two format conversion sections 533a and 533b.

One format conversion 533b functions by corresponding to the signal D showing 2457.8 Mbps from the clock circuit 535. The other format conversion section 533a starts up by having the signal D showing 2457.8 Mbps from the clock circuit as a startup signal, and functions by corresponding to the signal A1 of 1228.8 Mbps. The base band processing section 534 receives the signals L1, L2 outputted from the two format conversion sections 533a, 533b as the input, and executes base band processing on those signals.

This makes it possible to operate in a single clock circuit 535, even when the optical signals of different formats are inputted.

In the explanations above, it is described assuming the case where the transmission speeds of the signals A1 and A22 transmitted via the two signal transmission systems 511a, 511b are different. However, the third exemplary embodiment is not limited only to such case. The third exemplary embodiment can also be applied to a case where the signals transmitted via the two signal transmission systems 511a, 511b are the same and the transmission speeds thereof are equal. In this case, two signal transmission systems which transmit the signals with the same transmission speed are provided, so that it is possible to build those as a redundant structure.

In the explanations below, assumed is a case where: the signals are transmitted in the optical fibers 511a, 511b as the two signal transmission systems with the same transmission speed; and the switch 537 selects the signal C1 from the interface section 532a as the initial value in the initial state at the time of turning on the power, and outputs it to the clock circuit 535.

When the optical fiber 511a transmitting the signal A1 is disconnected, the signal C1 stops. The PLL 51 of the clock circuit 535 comes to be in an unlock state, and the clock circuit 535 outputs the signal F showing the unlock state of the PLL to the control section 536. Upon recognizing the unlock state, the control section 536 controls the switch 537 to switch the path to select the signal C2 from the interface section 532b.

In this case, the optical fiber 511b is operated properly, so that the signal C2 based on the signal A2 is outputted from the interface section 532b to the switch 537. Thus, the clock circuit 535 switches the switch 537 to have the signal C2 from the interface section 532b as the input. Therefore, the PLL 51 of the clock circuit 535 comes to be in a lock state based on the signal C2 from the interface section 532b and the signal E from the control section 536, and the clock circuit 535 outputs the signal D showing the lock state of the PLL to the format conversion section 533b. The format conversion section 533b operates based on the signal D. The base band processing section 534 executes base band processing by having the signal L2 from the format conversion section 533b of the proper signal transmission system as the input instead of the signal L1 from the format conversion section 533a of the fault signal transmission system.

As described, it is possible to operate the radio equipment by having the signal generated from the proper signal transmission system as the reference, even when either one of the optical fibers 511a and 511b as the two signal transmission systems is disconnected. This makes it possible to give the redundancy to the signals A1 and A2.

In the case described above, the REC 10 and the radio equipment 520 are connected via the two-system optical fibers 511a and 511b. However, it can be easily expanded so as to correspond to three systems or more.

Further, the operations of the radio equipment 20, 320, 520 according to the first to third embodiments of the present invention described above can be implemented as a program executed by a computer, assuming that the equipment is controlled by the computer.

While the present invention has been described by referring to specific embodiments shown in the drawings, the present invention is not limited only to those embodiments shown in the drawings. It is to be understood that any known structures can be employed as long as the effects of the present invention can be achieved therewith.

This Application claims the Priority right based on Japanese Patent Application No. 2008-068405 filed on Mar. 17, 2008 and Japanese Patent Application No. 2009-061124 filed on Mar. 13, 2009, and the disclosures thereof are hereby incorporated by reference in their entirety.

### INDUSTRIAL APPLICABILITY

The present invention is applicable to radio equipment that is connected to a REC via optical or electric signals.

### BRIEF DESCRIPTION OF THE DRAWINGS

FIG. 1 is a block diagram showing the structure of a mobile-communication radio base station device according to a first exemplary embodiment of the invention;

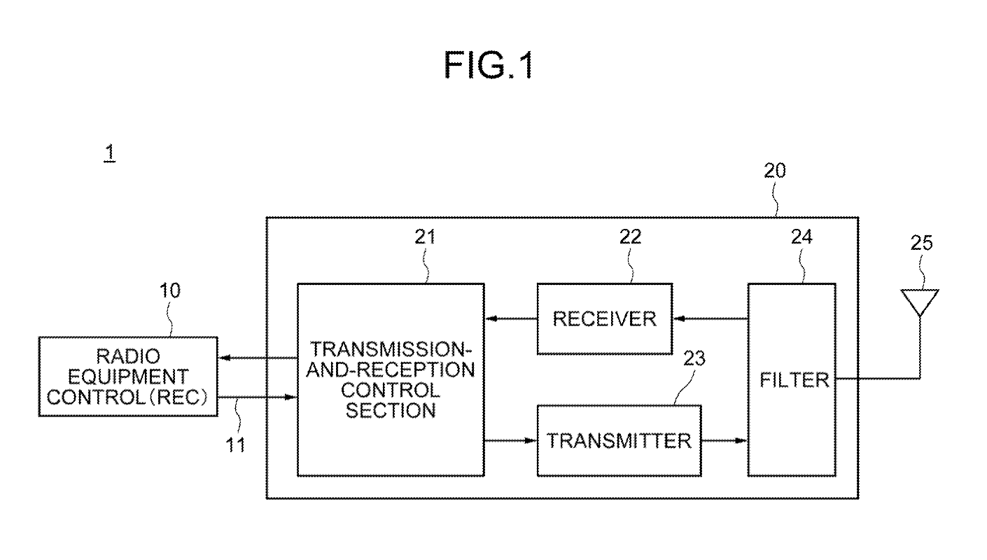

FIG. 2 is a block diagram showing the more detailed structure of a transmission-and-reception control section shown in FIG. 1;

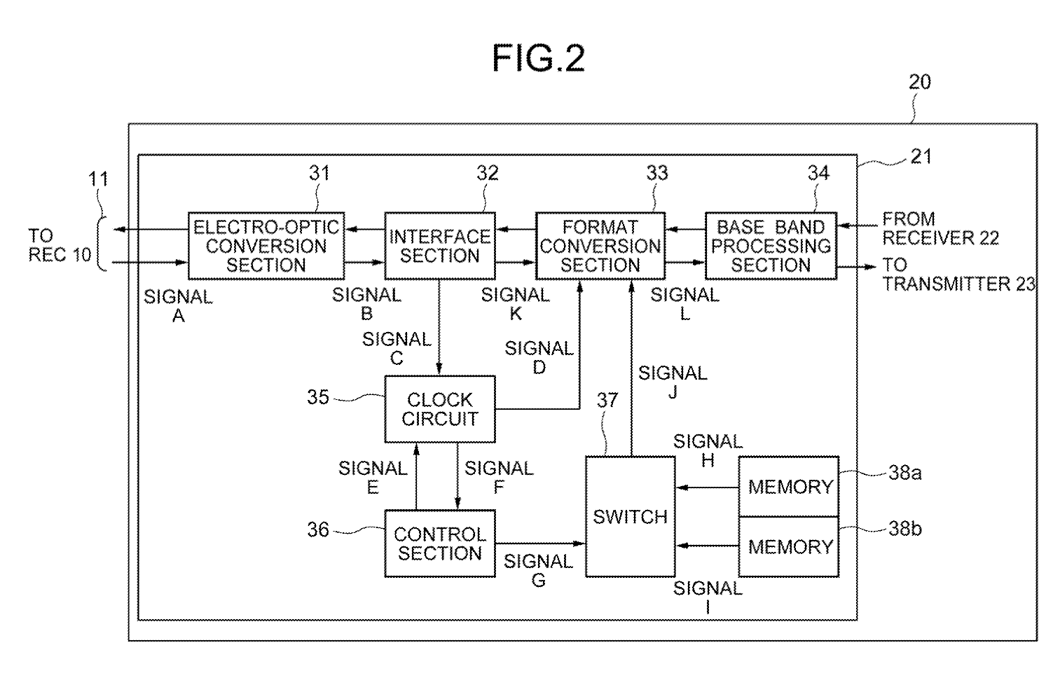

FIG. 3 is a block diagram showing the more detailed structure of an interface section shown in FIG. 2;

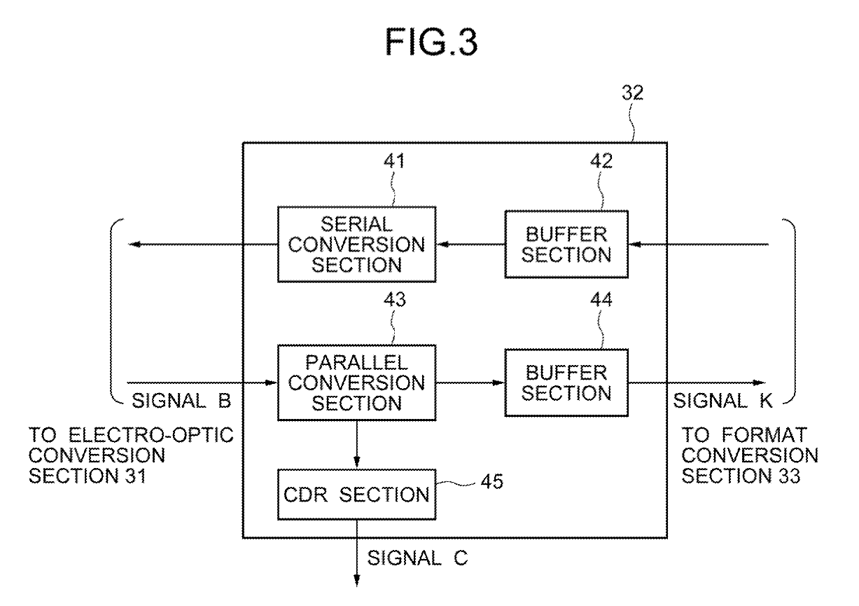

FIG. 4 is a block diagram showing the more detailed structure of a clock circuit shown in FIG. 2;

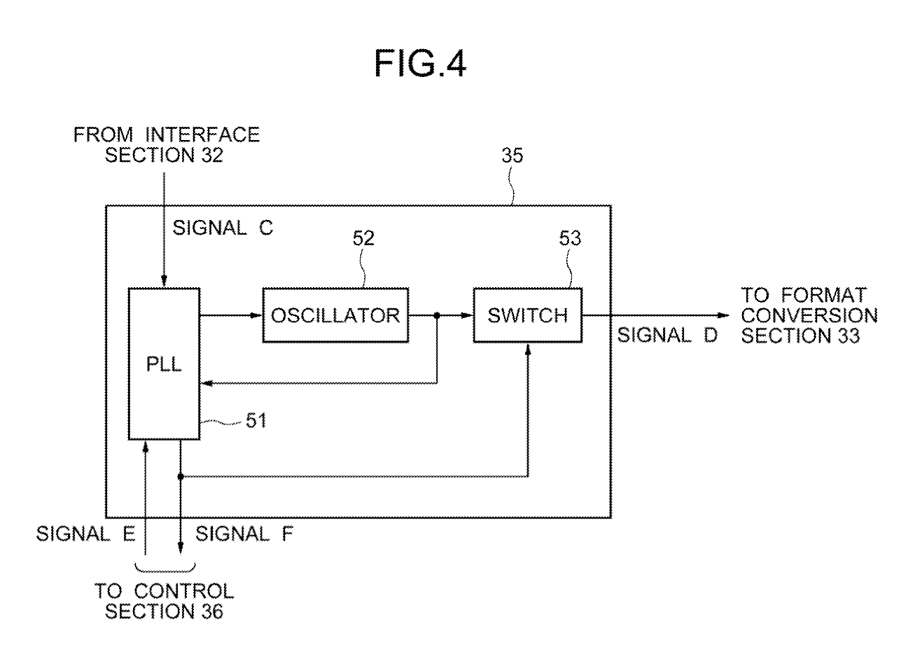

FIG. 5 is a flowchart showing operations at the time of starting up the radio equipment shown in FIG. 2-FIG. 4;

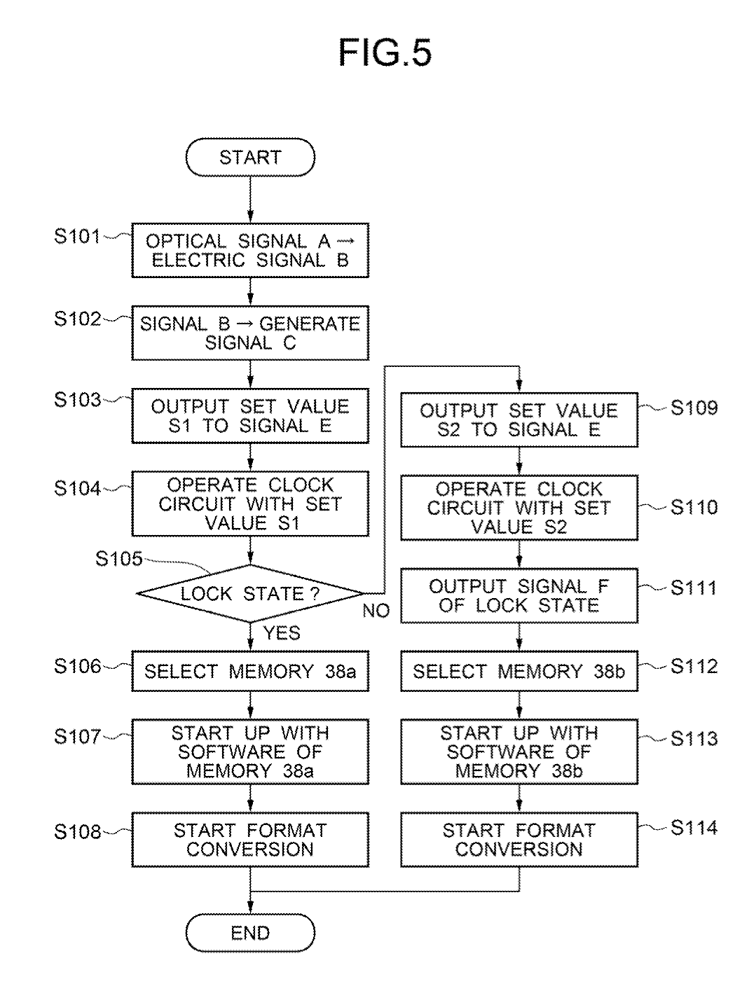

FIG. 6 is a flowchart showing operations executed when switched to CPRI of 1228.8 Mbps, while the radio equipment shown in FIG. 2-FIG. 4 is operating by corresponding to the transmission speed of 2457.6 Mbps;

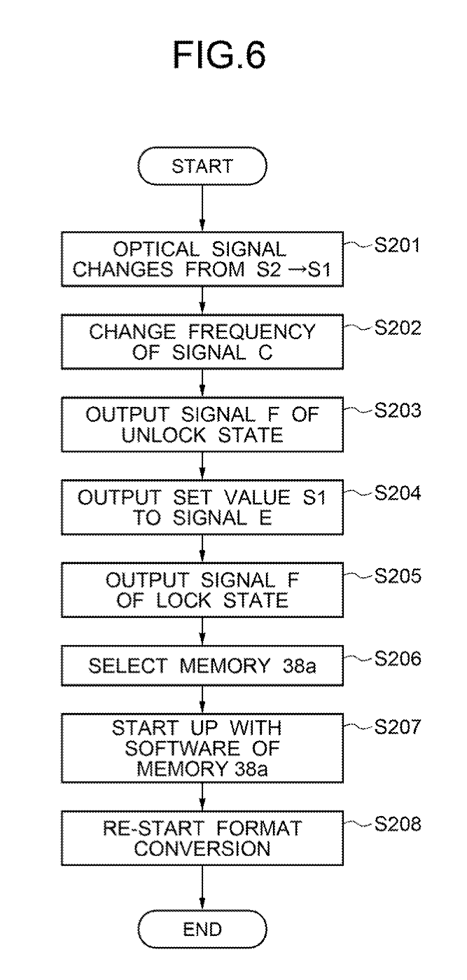

FIG. 7 is a block diagram showing the structure of radio equipment of a mobile-communication radio base station device according to a second exemplary embodiment of the invention;

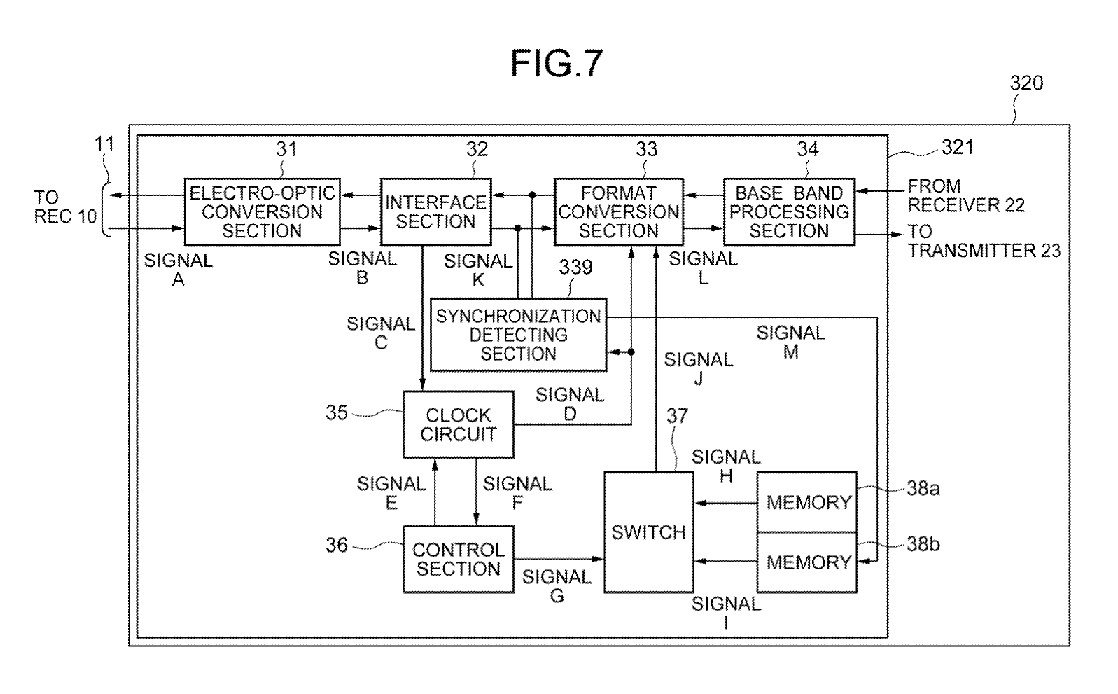

FIG. 8 is a flowchart showing operations at the time of starting up the radio equipment shown in FIG. 7; and

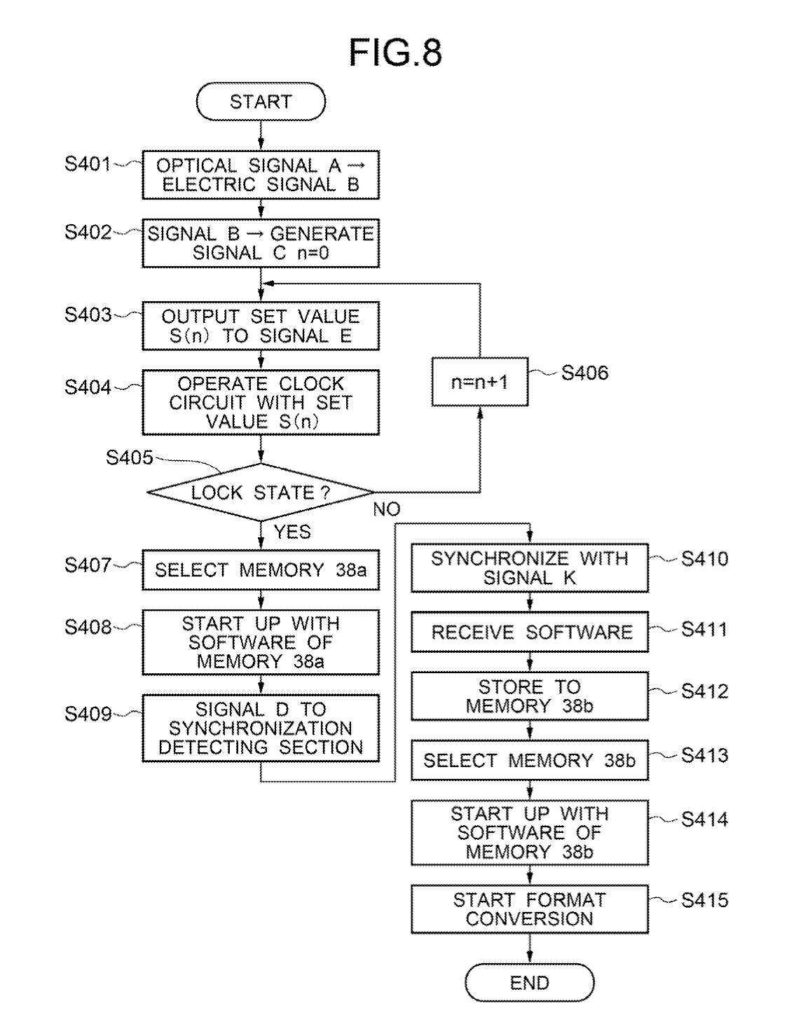

FIG. 9 is a block diagram showing the structure of radio equipment of a mobile-communication radio base station device according to a third exemplary embodiment of the invention.

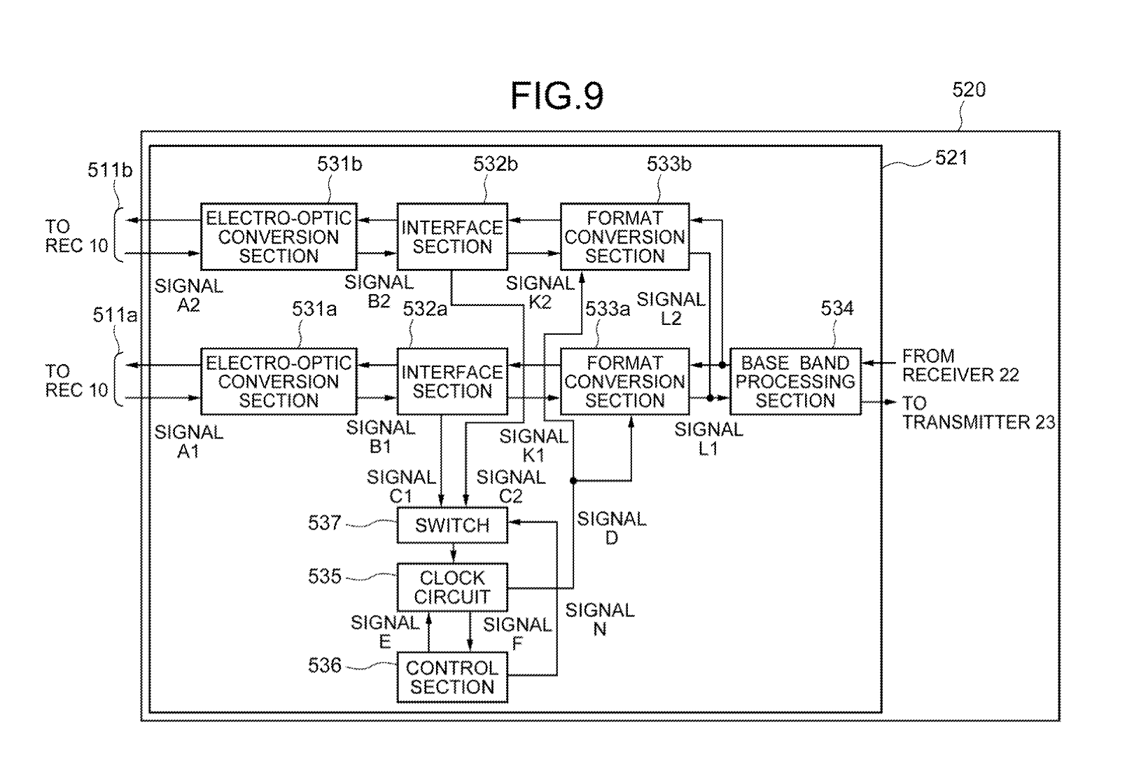

### REFERENCE NUMERALS

1 Mobile-communication radio base station device
10 REC
11, 511a, 511b Optical fiber
20, 320, 520 Radio equipment
21, 321, 521 Transmission-and-reception control section
22 Receiver
23 Transmitter
24 Filter
25 Antenna
31, 531a, 531b Electro-optic conversion section
32, 532a, 532b Interface section
33, 533a, 533b Format conversion section
34, 534 Base band processing section
35, 535 Clock circuit
36, 536 Control section
37, 537 Switch
38a, 38b Memory
41 Serial conversion section
42 Parallel conversion section
43 CDR section
44, 45 Buffer section
51 PLL
52 Oscillator
53 Switch
339 Synchronization detecting section

What is claimed is:

1. Radio equipment that operates by receiving transmission of a base band signal from a radio equipment control (REC), the radio equipment comprising:
an interface section that generates a parallel signal and a clock signal based on the base band signal;
a control section that outputs a signal of a specified value to be compared with the clock signal generated by the interface section; and
a clock circuit that detects whether or not the clock signal generated by the interface section coincides with the signal of the specified value outputted from the control section, and outputs a coincidence signal when both of the signals coincide with each other.

2. The radio equipment as claimed in claim 1, wherein:
the clock circuit includes a PLL (Phase Locked Loop) and an oscillator;
the PLL and the oscillator of the clock circuit operated by receiving the signal of the specified value outputted from the control section;
the clock circuit outputs the coincidence signal when the PLL is in a lock state, and outputs a non-coincidence signal when the PLL is in an unlock state; and
the control section switches a signal of different specified value and outputs the signal to the clock circuit by having the non-coincidence signal outputted from the clock circuit as a trigger.

3. The radio equipment as claimed in claim 1, comprising
a format conversion section that converts a format of the parallel signal outputted from the interface section by having the coincidence signal that is outputted from the clock circuit as a reference, when detecting coincidence between the clock signal generated by the interface section and the signal of the specified value outputted from the control section.

4. The radio equipment as claimed in claim 3, comprising a storage section that stores software required when the format conversion section executes format conversion, wherein:
when the clock circuit outputs the coincidence signal, the control section outputs to the storage section an instruction to read out the software corresponding to the signal of the specified value that is the base of the coincidence signal; and
the format conversion section downloads the software read out by the storage section for the format conversion by having the coincidence signal outputted from the clock circuit as a trigger.

5. The radio equipment as claimed in claim 3, wherein
the signal inputted to the interface section is a signal of an unknown transmission speed, the radio equipment comprising
a synchronization detecting section that synchronizes the coincidence signal outputted from the clock circuit and the parallel signal outputted from the interface section, acquires the software for the format conversion outputted from the REC when the synchronization is established, and stores the software to the storage section, and
a storage section that stores initial operation software required when the format conversion section executes an initial operation when power is turned on, wherein
the storage section stores the software from the synchronization detecting section after the power is turned on; and
the format conversion section downloads the software for the format conversion read out by the storage section by having the coincidence signal outputted from the clock circuit as a trigger.

6. The radio equipment as claimed in claim 1, comprising:
two signal transmission systems or more led to the interface section from the REC; and
a switch that selects the clock signal generated by the interface section included in the two signal transmission systems or more, and outputs the selected clock signal to the clock circuit, wherein
the control section outputs a selection instruction of the clock signal to the switch.

7. The radio equipment as claimed in claim 6, wherein
when detecting the coincidence between the clock signal generated by the interface section and the signal of the specified value outputted from the control section, the two signal transmission systems or more shares one format conversion section that converts the format of the parallel signal outputted from the interface section by having the coincidence signal outputted from the clock circuit as a reference.

8. A signal transmission speed determining method that determines a signal transmission speed in a signal transmission system operated by radio equipment upon receiving transmission of a base band signal from a radio equipment control (REC), the method comprising:
generating a parallel signal and a clock signal based on the base band signal;
outputting a signal of a specified value to be compared with the clock signal; and
detecting whether or not the clock signal coincides with the signal of the specified value, and outputting a coincidence signal when both of the signals coincide with each other.

9. The signal transmission speed determining method as claimed in claim 8, comprising:
operating a PLL (Phase Locked Loop) and an oscillator of a clock circuit based on the signal of the specified value;
switching the signal of a different specified value and outputting the signal when the PLL is in an unlock state; and
outputting the coincidence signal when the PLL is in a lock state.

10. The signal transmission speed determining method as claimed in claim 8, comprising:
converting a format of the parallel signal by having the coincidence signal as a reference.

11. The signal transmission speed determining method as claimed in claim 10, comprising:
executing the format conversion based on software read out by having the coincidence signal as a trigger.

12. The signal transmission speed determining method as claimed in claim 10, wherein the signal inputted to the interface section is a signal of an unknown transmission speed, the method comprising
executing an initial operation of the format conversion with initial operation software when power is turned on; and
synchronizing the coincidence signal and the parallel signal, acquiring the software for format conversion outputted from the REC when detecting the synchronization, and executing the format conversion with the software.

13. The signal transmission speed determining method as claimed in claim 8, comprising:
two signal transmission systems or more led to the interface section from the REC; and
selecting the clock signal generated by one of the two signal transmission systems or more, and detecting coincidence between the selected clock signal and the signal of the specified value.

14. The signal transmission speed determining method as claimed in claim 13, wherein
one format conversion is executed in common for the two signal transmission systems or more.

15. A non-transitory computer readable recording medium storing a transmission speed determining program that determines a signal transmission speed in a signal transmission system operated by radio equipment upon receiving transmission of a base band signal from a radio equipment control (REC), the program causing a computer to execute:
a function that generates a parallel signal and a clock signal based on the base band signal;
a function that outputs a signal of a specified value to be compared with the clock signal; and
a function that detects whether or not the clock signal coincides with the signal of the specified value, and outputs a coincidence signal when both of the signals coincide with each other.

16. The non-transitory computer readable recording medium storing the signal transmission speed determining program as claimed in claim 15, which uses a PLL (Phase Locked Loop) and an oscillator operating upon receiving the signal of the specified value, the program causing the computer to execute:
a function that outputs the coincidence signal when the PLL is in a lock state, and outputs a non-coincidence signal when the PLL is in an unlock state; and
a function that switches a signal of different specified value and outputs the signal by having the non-coincidence signal as a trigger.
